(19) United States
(12) Patent Application Publication
(10) Pub. No.: US 2021/0341674 A1
(43) Pub. Date: Nov. 4, 2021

(54) DOUBLE STRIPPING FIXTURE AND PROCESS FOR FIBER OPTIC CABLES

(71) Applicant: CommScope Technologies LLC, Hickory, NC (US)

(72) Inventors: Mark D. NARUM, Minnetonka, MN (US); Scott L. CARLSON, Bloomington, MN (US); Randall Kerry SANDHOLM, Minnetonka, MN (US); Jorge Carlos GAMEZ ESCALANTE, Ciudad Juarez (MX)

(21) Appl. No.: 17/245,432

(22) Filed: Apr. 30, 2021

Related U.S. Application Data
(60) Provisional application No. 63/018,223, filed on Apr. 30, 2020.

(51) Int. Cl. G02B 6/245

(52) U.S. Cl. CPC G02B 6/245

(57) ABSTRACT

The present disclosure relates to an improved stripping process that allows for double stripping in a fiber optic cable processing apparatus. The fiber optic cable processing apparatus has a double stripping fixture that includes a first set of blades configured for stripping a buffer layer off a fiber optic cable and a second set of blades for simultaneously stripping a buffer layer and a coating layer off the fiber optic cable. The double stripping fixture can also include spacers that are configured to set a gap between the first and second sets of blades.

This application claims the benefit of U.S. Provisional Application Ser. No. 63/018,223, filed Apr. 30, 2020, the disclosure of which is hereby incorporated by reference in its entirety.

### TECHNICAL FIELD

The present disclosure relates generally to fiber optic cable stripping machines. More specifically, the present disclosure relates to a fiber optic cable processing apparatus with a stripping fixture to remove jackets, buffers and coatings around bare glass of a fiber optic cable.

### BACKGROUND

There are a variety of prior art devices for stripping fiber optic cables. The desired effect is for the blades to remove the outer jacket and/or the buffer layer. Other times a desired effect is to remove the coating layer from the underlying fiber.

Even though existing devices allow for stripping fiber optic cables, improvements are needed.

### SUMMARY

The present disclosure relates to an improved stripping process that allows for double stripping in a fiber optic cable processing apparatus. The double stripping process and related fixture includes two sets of blades for simultaneously cutting a fiber optic cable relative to a jacket and a coating.

In one aspect of the present disclosure relates, a first set of blades are configured for stripping a buffer layer off a fiber optic cable. In one example, the first set of blades each define a semi-circular notch that forms a first circular diameter when the first set of blades come together in a stripping operation.

Another aspect of the present disclosure relates to a second set of blades that are configured for stripping a buffer layer and a coating layer off a fiber optic cable. In one example, the second set of blades each define a semi-circular notch that forms a second circular diameter when the second set of blades come together in a stripping operation.

Another aspect of the present disclosure relates to spacers that can be used with the fiber optic cable processing apparatus to set a gap between the first and second sets of blades.

In one example, the spacers are fixed or stationary such that during operation, the first and second sets of blades are configured to move past the spacers to perform the stripping operation.

Another aspect of the present disclosure relates to including a centralizer for aligning a fiber optic cable horizontally and vertically with respect to the first and second sets of blades configured to come together to strip a layer surrounding an optical fiber.

A further aspect of the present disclosure relates to a method of removing a protective layer and a coating layer from a fiber optic cable. The method can include a step of providing a cable stripping tool. The cable stripping tool can include a clamp that is adapted to move axially to strip the protective and coating layers. The cable stripping tool can also include first and second sets of blades adapted to move radially inward and radially outward. The first set of blades can be spaced apart from the second set of blades by a spacer that can create a gap therebetween.

The method can also include a step of moving the first and second sets of blades radially inward to engage the fiber optic cable. The method can also include a step of cutting the fiber optic cable to a first depth that extends through the protective layer of the fiber optic cable to expose the coating layer and simultaneously cutting the fiber optic cable to a second depth that extends through the protective layer and the coating layer of the fiber optic cable to expose a bare fiber.

The method can further include a step of moving the clamp axially in a direction away from the first and second sets of blades to strip the protective layer and the coating layer from the fiber optic cable.

These and other features and advantages will be apparent from a reading of the following detailed description and a review of the associated drawings. A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of a fiber optic cable stripping device that includes a double stripping fixture in accordance with principles of the present disclosure;

FIG. 2 is a front perspective view of the double stripping fixture of FIG. 1;

FIG. 3 is a rear perspective view of the double stripping fixture of FIG. 2;

FIG. 4 is a front view of the double stripping fixture of FIG. 2;

FIG. 5 is a rear view of the double stripping fixture of FIG. 4;

FIG. 6 is a top perspective view of a guide plate of the double stripping fixture shown in FIG. 2;

FIG. 7 is a bottom perspective view of the guide plate of FIG. 6;

FIG. 8 is an exploded view of the double stripping fixture of FIG. 2 showing the guide plate, first and second sets of blades, first and second spacers, a centralizer, and a cover plate;

FIG. 9 is an exploded view of the first and second sets of blades, first and second spacers and the centralizer of FIG. 8;

FIG. 10 is a perspective front view of the first and second sets of blades, first and second spacers and the centralizer of FIG. 9 assembled together;

FIG. 11 is a perspective rear view of the assembly shown in FIG. 10;

FIG. 12 is a top view of the assembly shown in FIG. 10 with the first and second sets of blades in a closed position in accordance with the principles of the present disclosure;

FIG. 13 is a top view of the assembly of FIG. 12 with the first and second sets of blades in an open position in accordance with the principles of the present disclosure;

FIG. 14 is a perspective view of the first and second blades of FIG. 9;

FIG. 15 is an enlarged view of a portion of the first and second blades of FIG. 14 depicting the semi-circular notches in accordance with the principles of the present disclosure;

FIG. 16 is an end view of the first set of blades in a closed position to form a first stripping hole in accordance with the principles of the present disclosure;

FIG. 17 is an end view of the second set of blades in a closed position to form a second stripping hole in accordance with the principles of the present disclosure;

FIG. 18 is a top perspective view of the second set of blades shown in FIG. 17;

FIG. 19 is a top perspective view of the second set of blades of FIG. 18 shown with a fiber optic cable through the second stripping hole;

FIG. 20 is a perspective view of the spacer shown in FIG. 9;

FIG. 21 is a perspective view of the centralizer shown in FIG. 9;

FIGS. 22-24 are multiple views of the double stripping fixture of FIG. 2, using hidden lines, showing the first and second sets of blades, centralizer, spacer, and cover in the open position prior to a stripping operation; and

FIGS. 25-27 are multiple views of the double stripping fixture of FIG. 2, using hidden lines, showing the first and second sets of blades, centralizer, spacer, and cover in the closed position during the stripping operation.

### DETAILED DESCRIPTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

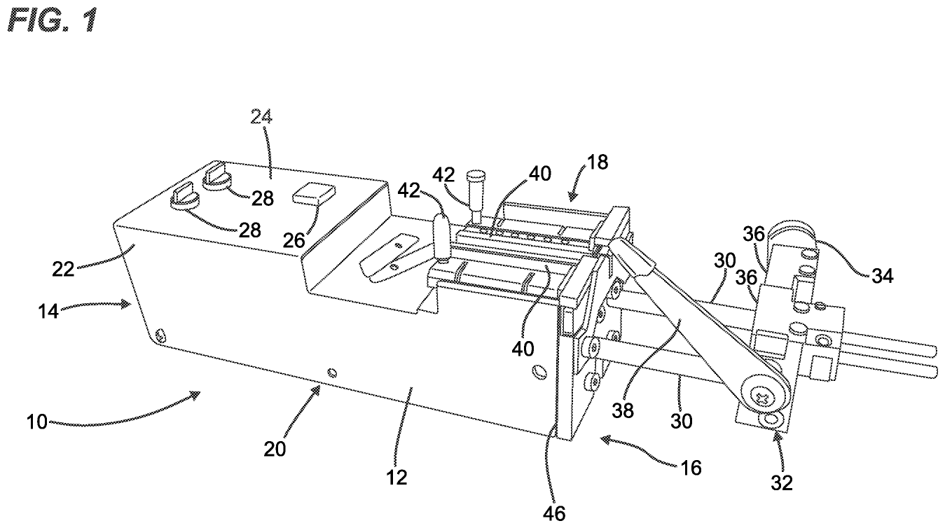

FIG. 1 illustrates an example fiber optic cable processing apparatus 10 (e.g., a fiber optic cable stripping device) that can be configured to remove one or more protective layers (e.g., coating, buffer, etc.) from an optical fiber. A fiber optic cable stripping device similar to the fiber optic cable processing apparatus 10 illustrated in FIG. 1 is available from Schleuniger AG under the model name “Fiber Strip 7030” and is described in detail in U.S. Pat. No. 6,321,621, the entire disclosure of which is incorporated herein by reference.

The fiber optic cable processing apparatus 10 can include a main body 12 defining a first end 14, a second end 16, a right side 18 and a left side 20. At the first end 14 of the main body 12 is located a control housing 22 that houses control electronics for operation of the fiber optic cable processing apparatus 10. At a top surface 24 of the control housing 22 is located a start/reset button 26 for initiating the stripping process and returning the fiber optic cable processing apparatus 10 to the original starting position after stripping. The fiber optic cable processing apparatus 10 can be arranged and configured to apply heat on layers surrounding an optical fiber for facilitating the stripping process. Control knobs 28 for setting the heating time and temperature of the fiber optic cable processing apparatus 10 are also located on the top surface 24 of the control housing 22.

The main body 12 comprises an internal frame which supports a pair of connecting rods 30. At the second end 16 of the main body 12, adjacent a front end of the connecting rods 30, is mounted a clamping structure 32 for clamping a fiber optic cable to be stripped. When the fiber optic cable processing apparatus 10 is activated, the clamping structure 32 can be moved by the connecting rods 30 in a direction extending away from the control housing 22 for stripping a fiber optic cable. A collar 34 can be used for adjusting the clamping force of the clamping jaws 36 which are held by spring force in a closed position. When the fiber optic cable is ready to be inserted between the clamping jaws 36, the clamping jaws 36 can be opened by a release lever 38.

In operation, the length of fiber optic cable to be stripped is laid between a pair of heating jaws 40 located adjacent the second end 16 of the main body 12. The pair of heating jaws 40 can be disposed on the fiber optic cable processing apparatus 10 and include control handles 42 for bringing the pair of heating jaws 40 into position. The pair of heating jaws 40 can be arranged and configured to apply heat to a length of fiber optic cable to be stripped as the clamping structure 32 pulls the stripped optical fiber away from the pair of heating jaws 40.

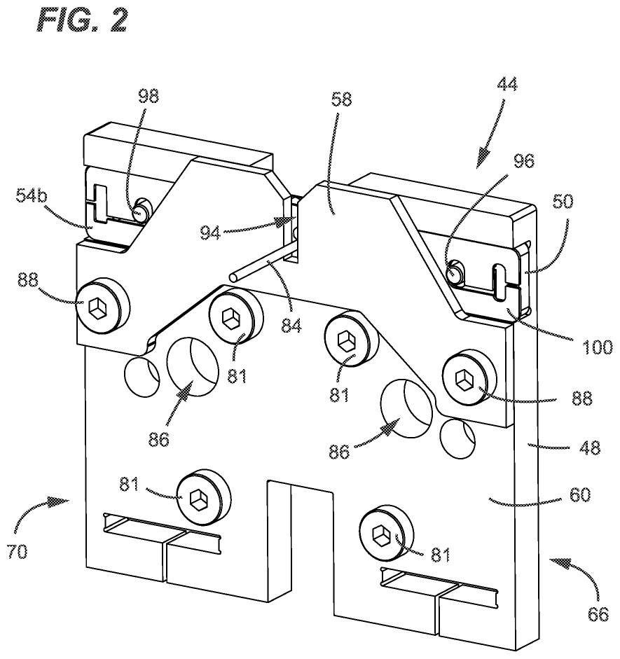

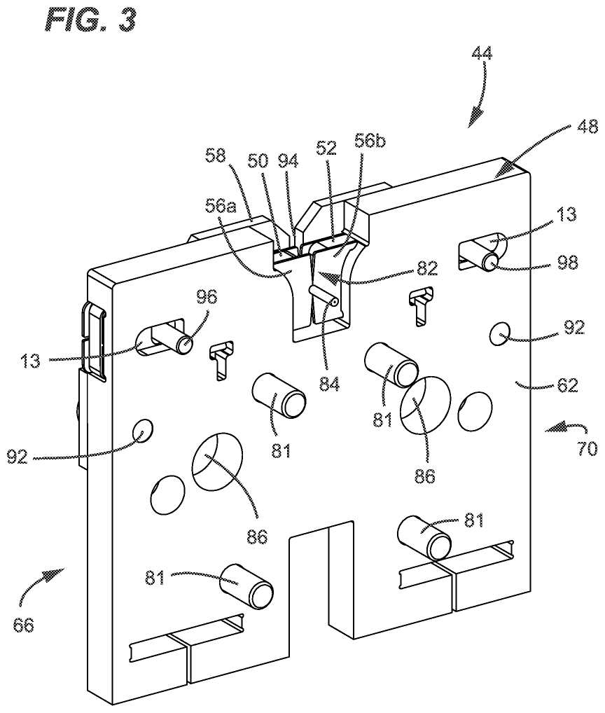

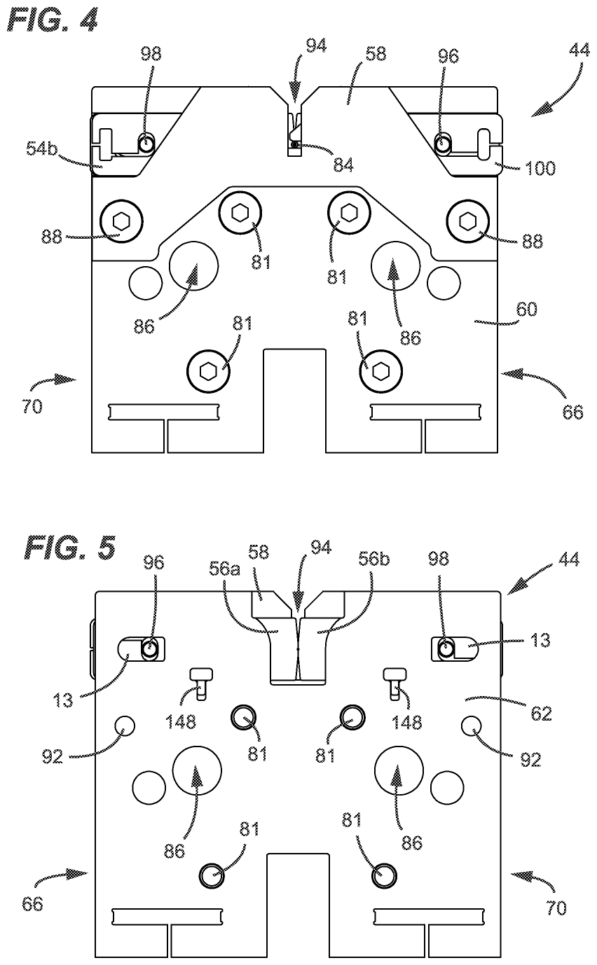

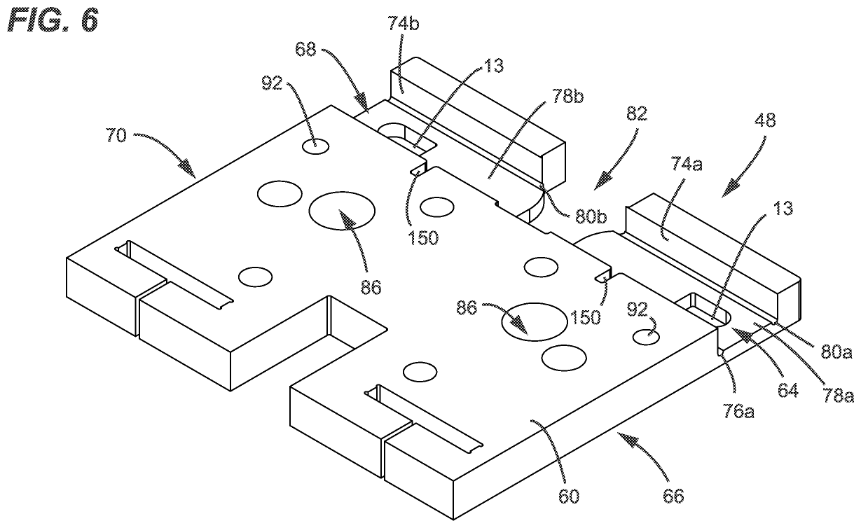

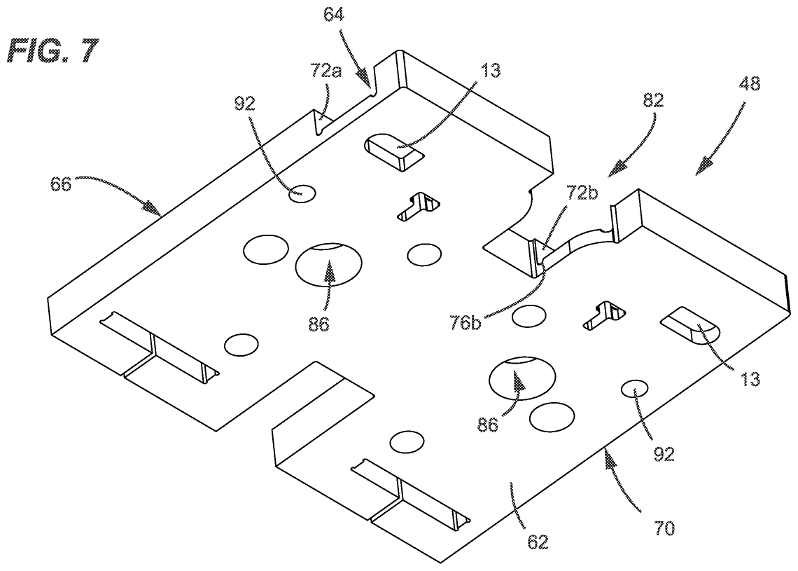

Referring to FIGS. 2-7, an example double stripping fixture 44 is illustrated. The double stripping fixture 44 can be mounted at a front face 46 of the main body 12. The double stripping fixture 44 can include a guide plate 48, a first spacer 50, a second spacer 52, a first set of blades 54a, 54b, a second set of blades 56a, 56b, and a cover plate 58.

The guide plate 48 includes a first face 60 and an opposing second face 62. The guide plate 48 can define a first channel 64 at a first side 66 thereof and an opposing, second channel 68 at a second side 70 thereof such that the first and second channels 64, 68 are aligned parallel to each other. The first and second channels 64, 68 are defined by respective first walls 72a, 72b and second walls 74a, 74b of the guide plate 48. The first walls 72a, 72b respectively define a first groove 76a 76b relative to respective bases 78a, 78b of the first and second channels 64, 68. The second walls 74a, 74b respectively define a second groove 80a, 80b relative to the respective bases 78a, 78b of the first and second channels 64, 68. A cutout 82 (e.g., space) is defined between the first and second channels 64, 68 and the second walls 74a, 74b for receiving the first and second spacers 50, 52, the first set of blades 54a, 54b, the second set of blades 56a, 56b and a fiber optic cable 84 during operation of the fiber optic cable processing apparatus 10.

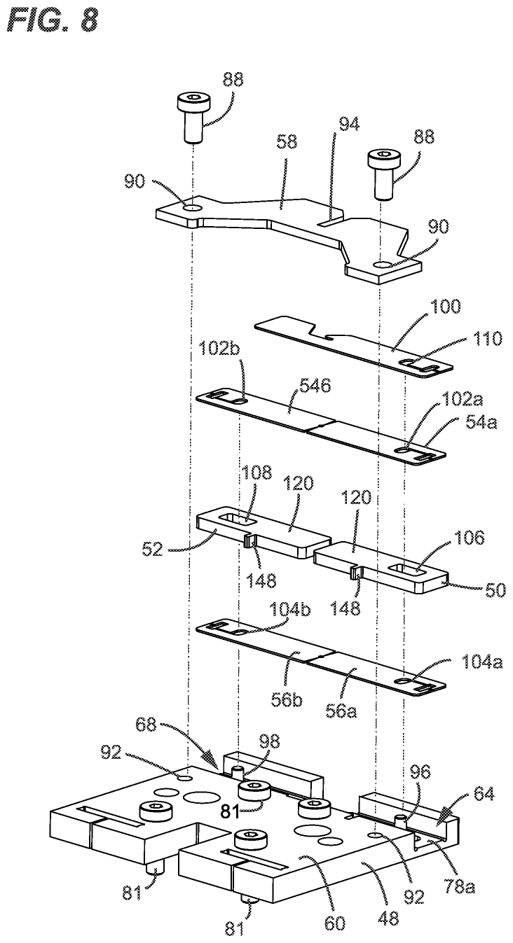

The guide plate 48 can further define apertures 86 for receiving the connecting rods 30 at the second end 16 of the main body 12. The cover plate 58 can be secured to the guide plate 48 via fasteners 88 (e.g., bolt, screw, rivet, etc.). That is, the cover plate 58 can define a pair of fastener openings 90 (see FIG. 8) that align with openings 92 defined in the guide plate 48. The fasteners 88 can extend through both the fastener openings 90 and the openings 92 of the guide plate 48 to mount the cover plate 58 to the guide plate 48. Fasteners 81 can be utilized to mount the guide plate 48 to the fiber optic cable processing apparatus 10 adjacent the second end 16 of the main body 12 of the fiber optic cable processing apparatus 10. The cover plate 58 can define a slot 94 for receiving the fiber optic cable 84 during operation of the fiber optic cable processing apparatus 10. The first and second sets of blades 54a, 54b, 56a, 56b, the first and second spacers 50, 52, and the centralizer 100 are held together in the first and second channels 64, 68 by the cover plate 58.

Turning to FIG. 8, an exploded view of the double stripping fixture 44 is depicted. Pegs 96, 98 (e.g., pins, dowels) can be supported by the fiber optic cable processing apparatus 10 to extend from the front face 46 of the main body 12 to support the double stripping fixture 44. The pegs 96, 98 are shown extending into openings 13 defined in the first and second channels 64, 68 respectively. The pegs 96, 98 pass through the first and second set of blades 54a, 54b, 56a, 56b and the first and second spacers 50, 52 in the first and second channels 64, 68 when the double stripping fixture 44 is mounted to the fiber optic cable processing apparatus 10. During operation of the fiber optic cable processing apparatus 10, the pegs 96, 98 can be configured to control the first and second set of blades 54a, 54b to move the first and second set of blades 54a, 54b radially back and forth (e.g., in and out).

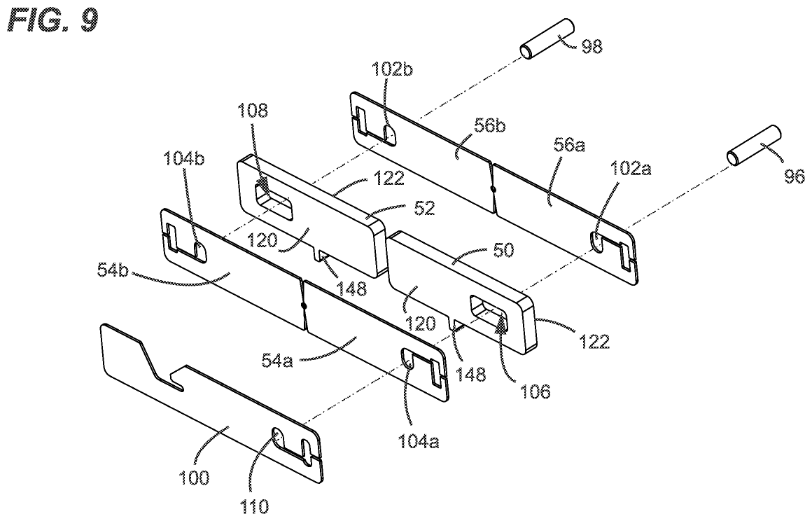

Referring to FIG. 9, the first and second sets of blades 54a, 54b, 56a, 56b each define an opening 102a, 102b, 104a, 104b for receiving the pegs 96, 98, respectively, which move the first and second set of blades 54a, 54b in and out of the first and second channels 64, 68. The first and second spacers 50, 52 also define respective openings 106, 108 for respectively receiving the pegs 96, 98.

The second set of blades 56a, 56b can be positioned adjacent the bases 78a, 78b of the first and second channels 64, 68. The first and second spacers 50, 52 are provided adjacent to both the first and second sets of blades 54a, 54b, 56a, 56b. That is, the first and second spacers 50, 52 can be positioned between the first and second sets of blades 54a, 54b, 56a, 56b. The first and second spacers 50, 52 provide the appropriate spacing for the first and second sets of blades 54a, 54b, 56a, 56b. Although two spacers are shown, it will be appreciated that a single spacer may also be used.

In certain examples, the double stripping fixture 44 can include a centralizer 100 (e.g., centering structure) that is configured to provide vertical and horizontal alignment of the fiber optic cable 84 with respect to the first and second sets of blades 54a, 54b, 56a 56b. The centralizer 100 can be mounted from the first side 66 of the guide plate 48 to extend into both the first and second channels 64, 68, although alternatives are possible. The centralizer 100 can define an opening 110 for receiving the peg 96 when mounted to the double stripping fixture 44. In certain examples, the centralizer 100 can be positioned adjacent to the first set of blades 54a 54b and the cover plate 58.

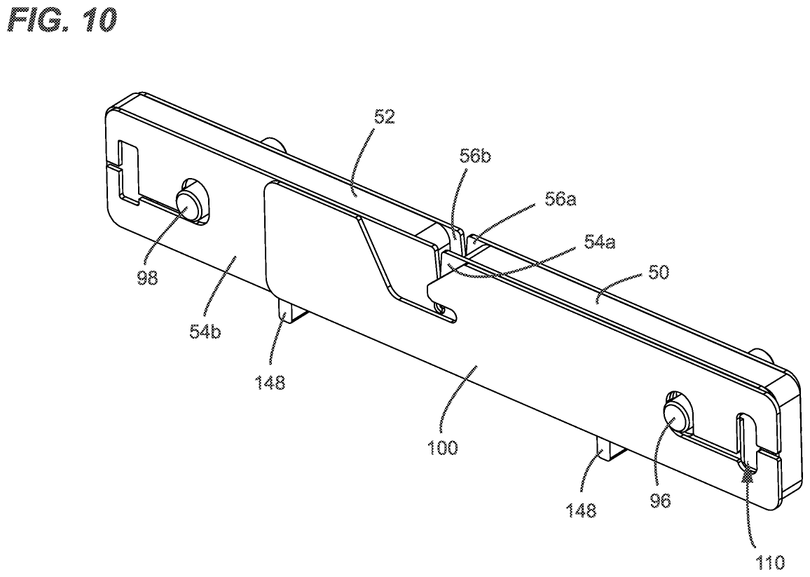

FIGS. 10-11 show the first and second sets of blades 54a, 54b, 56a, 56b, the first and second spacers 50, 52, and the centralizer 100 as they would be assembled together when mounted over the pegs 96, 98 of the fiber optic cable processing apparatus 10. The first and second sets of blades 54a, 54b, 56a, 56b, the first and second spacers 50, 52, and the centralizer 100 can be removably mounted parts for use with the fiber optic cable processing apparatus 10. The first and second sets of blades 54a, 54b, 56a, 56b, the first and second spacers 50, 52, cover plate 58, and/or the centralizer 100 may be constructed of various metals and/or other materials.

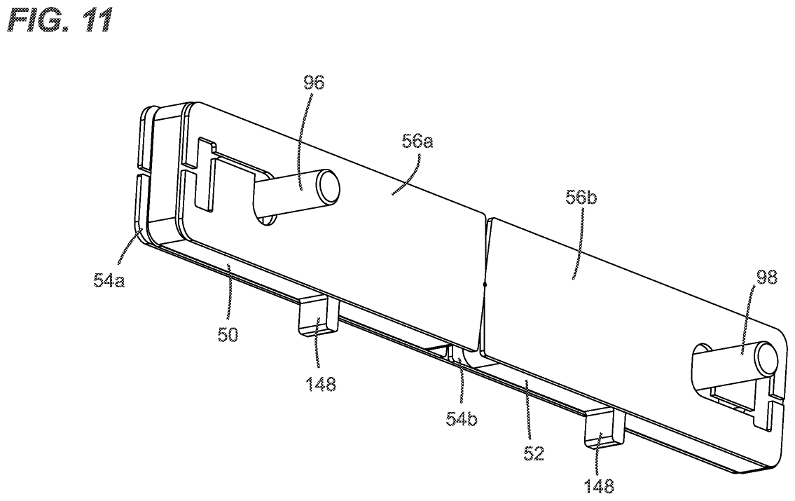

Turning to FIGS. 12-14, the first and second sets of blades 54a, 54b, 56a, 56b and the centralizer 100 are configured to fit over pegs 96, 98. For further details of the configuration and the operation of a fiber optic cable processing apparatus similar to FIG. 1, please refer to U.S. Pat. No. 6,321,621, the entire disclosure of which has been incorporated herein by reference. It should be noted that various types of blades can be used with the fiber optic cable processing apparatus 10 of FIG. 1, depending upon the type of fiber optic cable that is being stripped.

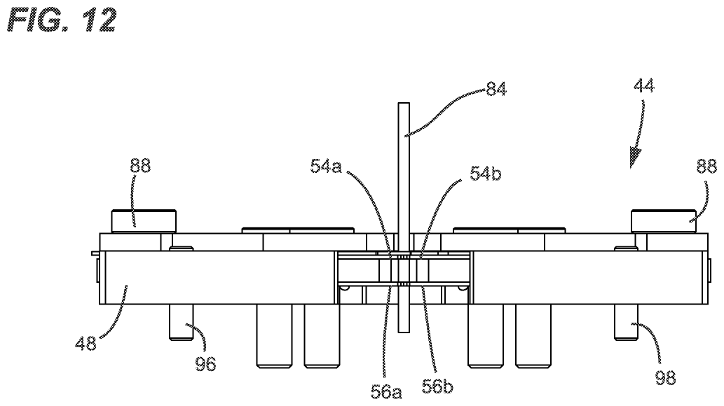

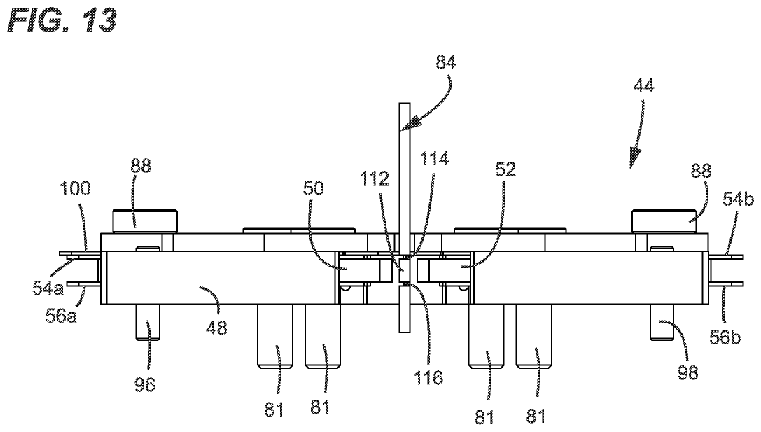

Referring to FIGS. 12 and 13, a top view of the double stripping fixture 44 is depicted. The double stripping fixture 44 includes the first and second sets of blades 54a, 54b, 56a, 56b, which are configured for use with the fiber optic cable processing apparatus 10. During operation, the first and second sets of blades 54a, 54b, 56a, 56b are configured to perform a double stripping action to strip the fiber optic cable 84. The double stripping fixture 44 can be configured to strip both a buffer layer 112 and a coating layer 114 of the fiber optic cable 84 to provide a more precise stripping process. That is, the fiber optic cable processing apparatus 10 can be utilized to perform a combination cutting function which eliminates the need for two separate machines to perform the stripping of the buffer layer 112 and the coating layer 114. In certain examples, the buffer layer 112 is a 900 micrometer tight-buffer, although alternatives are possible. The buffer layer 112 can be bonded to the coating layer 114 of about 250 micrometers, which surrounds a bare fiber 116 of about 125 micrometers.

During the stripping operation, when the first and second sets of blades 54a, 54b, 56a, 56b come together to capture the fiber optic cable 84 as shown in FIG. 12, the first set of blades 54a, 54b can be configured to contact a buffer layer 112 of the fiber optic cable 84 and the second set of blades 56a, 56b can be configured to contact the buffer layer 112 and a coating layer 114 of the fiber optic cable 84. FIG. 13 shows the first and second sets of blades 54a, 54b, 56a, 56b pulled apart after cutting through the buffer layer 112 and the coating layer 114 to expose the bare fiber 116. The buffer layer 112 and the coating layer 114 can be stripped directly off the fiber at the same time leaving the 125 micrometer of exposed fiber. That is, the 250 micrometer coating layer 114 may extend past the 900 micrometer buffer layer 112 a desired gap from which the bare fiber is provided.

In certain examples, the gap can be about 2 millimeters, although alternatives are possible. In certain examples, the gap can be about 4 millimeters, although alternatives are possible. In another example, the gap can be at least 1 millimeter to 4 millimeters. In other examples, the gap can be at least 1 millimeter to 3 millimeters. In certain examples, the gap can be 1.5 millimeters to 2.5 millimeters.

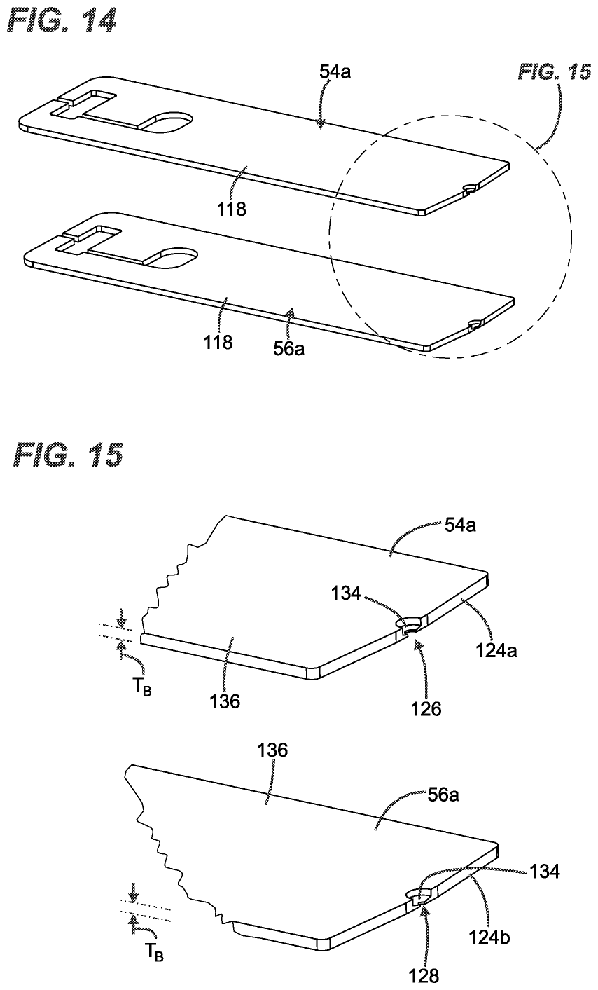

Turning to FIGS. 14-15, the first and second blades 54a and 56a are depicted. The first and second blades 54b, 56b have the same configuration as the first and second blades 54a, 56a, respectively, and form a mirror image of the first and second blades 54a, 56a. As such, only the first and second blades 54a, 56a will be described in detail. It will be appreciated that the same features of the first and second blades 54a, 56a will apply to the first and second blades 54b, 56b.

The first and second blades 54a, 55a have features that are examples of aspects in accordance with the principles of the present disclosure. The first and second blades 54a, 56a each include a plate 118 having a generally rectangular configuration. The first and second blades 54a, 56a can be oriented in the first and second channels 64, 68 such that the first set of blades 54a 54b, are positioned adjacent a first major surface 120 (see FIG. 9) of the first and second spacers 50, 52, respectively. Also, the second set of blades 56a, 56b are positioned adjacent to a second major surface 122 (see FIG. 9) of the first and second spacers 50, 52, respectively.

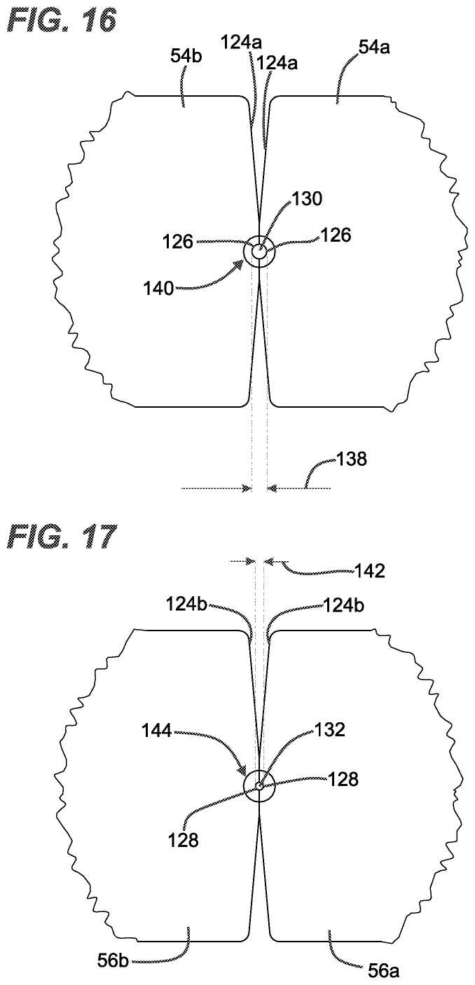

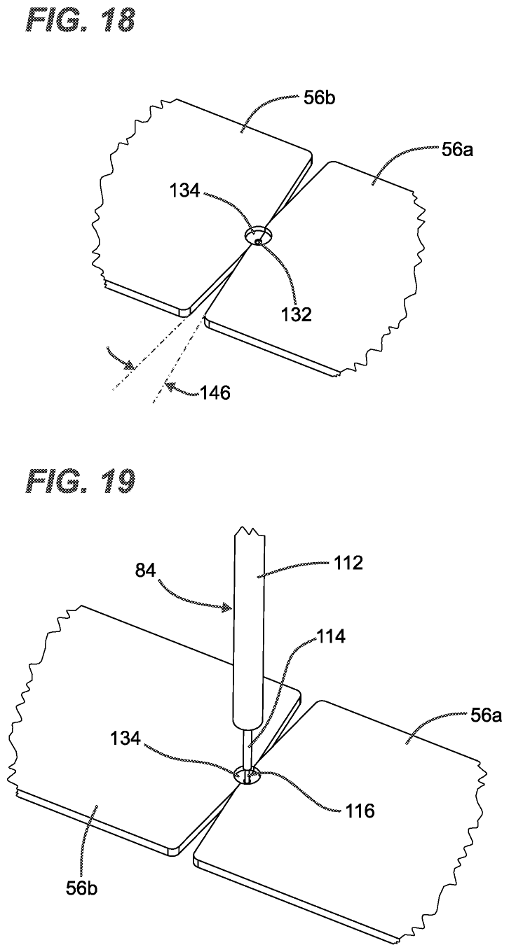

Referring to FIGS. 16-19, the first and second sets of blades 54a, 54b, 56a, 56b each include stripping ends 124a, 124b (see FIG. 15) that respectively define semi-circular notches 126, 128 (see FIG. 15). When the first set of blades 54a, 54b come together for the stripping operation, the semi-circular notches 126 form a stripping hole 130. Similarly, when the second set of blades 56a, 56b come together for the stripping operation, the semi-circular notches 128 form a stripping hole 132. Thus, the first and second sets of blades 54a, 54b, 56a, 56b are configured to surround the fiber optic cable 84 in the stripping holes 130, 132. By varying certain dimensions of the blades (e.g., increasing or decreasing the diameter of the stripping hole), blades for stripping other types of fiber optic cables (e.g., 900 micrometer loose-buffer) may be provided.

The first and second blades 54a, 56a can each include a cavity 134 defined in a top surface 136 of the plate 118 that respectively surrounds the stripping holes 130, 132. The first and second sets of blades 54a, 54b, 56a, 56b can be mounted in the first and second channels 50, 52 of the guide plate 48 such that the cavities 134 faces away from the clamping structure 32 of the fiber optic cable processing apparatus 10. As such, when the fiber optic cable 84 is being stripped, the cavities 134 can accommodate the collected buffer layer 112 or the coating layer 114 being stripped.

In certain examples, the first and second blades 54a, 56a can have a thickness TB of about 0.012 inches, although alternatives are possible. The stripping hole 130 can have a diameter 138 formed when the first set of blades 54a, 54b come together for stripping a 900 micrometer tight-buffer fiber optic cable. The cavity 134 of the first set of blades 54a, 54b can also have a diameter 140 formed around the stripping hole 130. The stripping hole 132 can have a diameter 142 formed when the second set of blades 56a, 56b come together for stripping a 900 micrometer tight-buffer and the coating layer 114 of the fiber optic cable 84.

The cavity 134 of the second set of blades 56a, 56b can also have a diameter 144 formed around the stripping hole 132. In certain examples, the diameter 138 of the stripping hole 130 formed by the first set of blades 54a, 54b can be larger than the diameter 142 of the stripping hole 132 formed by the second set of blades 56a, 56b. As such, the diameter 138 can be configured to cut into the buffer layer 112 only while the diameter 142 can be configured to cut into both the buffer layer 112 and the coating layer 114. When the first and second sets of blades 54a, 54b, 56a, 56b come together, the respective stripping ends 124a, 124b can form an angle 146 (see FIG. 18) relative to a vertical plane.

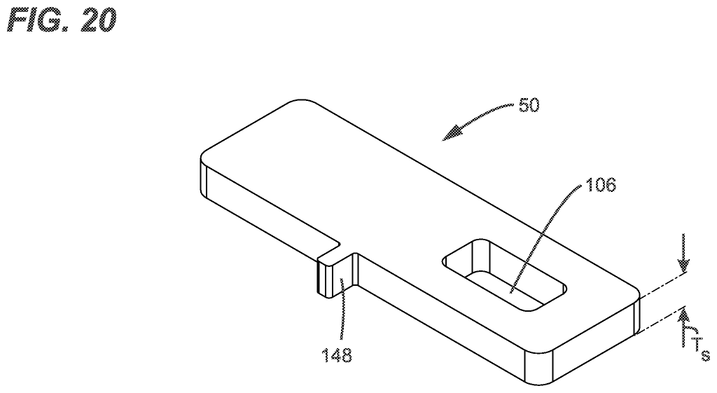

Turning to FIG. 20, a perspective view of one of the first and second spacers 50, 52 is shown. The first and second spacers 50, 52 are designed to be mounted within the first and second channels 64, 68 of the guide plate 48 between the first and second sets of blades 54a, 54b, 56a, 56b. The first and second spacers 50, 52 are configured to provide the appropriate spacing for the first and second sets of blades 54a, 54b, 56a, 56b. In certain examples, the first and second spacers 50, 52 are configured to provide a 2 millimeter spacing between the first and second sets of blades 54a, 54b, 56a, 56b, although alternatives are possible. The first and second spacers 50, 52 can have a thickness Tₛ of about 2 millimeters, although alternatives are possible. In certain examples, a thicker spacer may be needed to provide a larger gaps. As such, a 4 millimeter spacer or larger may be used, although alternatives are possible. During the stripping operation by the fiber optic cable processing apparatus 10, when the first and second sets of blades 54a, 54b, 56a, 56b come together to capture the fiber optic cable 84, the first and second spacers 50, 52 remain stationary or fixed relative to the guide plate 48.

The first spacer 50 has the same configuration as the second spacer 52 and forms a mirror image of the second spacer 52. As such, only the first spacer 50 will be described. The first spacer 50 includes a leg 148 for fixing the first spacer 50 within the first channel 64. That is, the second walls 74a, 74b of the first and second channels 50, 52 can define a slot 150 for receiving the leg 148 when the first and second spacers 50, 52 are respectively mounted in the first and second channels 64, 68. As such, the first and second spacers 50, 52 are fixed or stationary during operation of the fiber optic cable processing apparatus 10. The first spacer 50 has a generally rectangular configuration and a generally rectangular opening 106 for mounting the first spacer 50 to the fiber optic cable processing apparatus 10.

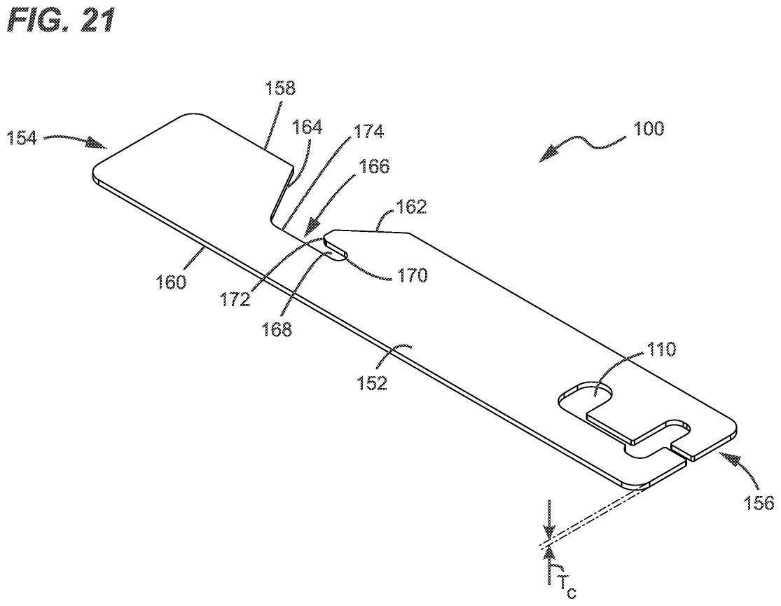

Referring to FIG. 21, a perspective view of the centralizer 100 is depicted. In certain examples, the centralizer 100 can be configured for use with the fiber optic cable processing apparatus 10. The centralizer 100 can help to align the fiber optic cable 84 vertically and horizontally and to center the fiber optic cable 84 with respect to the first and second sets of blades 54a, 54b, 56a, 56b. Thus, the centralizer 100 can be arranged and configured to help prevent any damage to the fibers during the stripping process.

The centralizer 100 can be mounted into the guide plate 48 at the first side 66. The centralizer 100 has features that are examples of aspects in accordance with the principles of the present disclosure. Another example of a centralizer or centering structure is described in detail in U.S. Pat. No. 7,681,476, the entire disclosure of which is incorporated herein by reference.

The centralizer 100 generally includes a rectangular plate 152 extending between a first end 154 and a second end 156. The centralizer 100 includes a top end 158 and a bottom end 160. Adjacent the second end 156 of the plate 152, the top end 158 of the plate 152 includes downwardly angled portions 162, 164 that defines an open end 166. The plate 152 also defines an elongate groove 168 with a circular closed end 170. The groove 168 can be accessed through the open end 166 and includes a tapering-out portion 172. The tapering-out portion 172 can assists entry of the fiber into the groove 168 as the first and second sets of blades 54a, 54b, 56a, 56b come together. The elongate groove 168 may also include a top edge 174 where the fiber optic cable 84 is configured to rest. The top edge 174 provides a vertical stop for the buffer of the fiber optic cable 84 during the stripping operation. The angled portion 162 may assist in initially laying the fiber optic cable 84 onto the top edge 174 defined by the groove 168. The fiber optic cable 84 is horizontally aligned perfectly with the first and second sets of blades 54a, 54b, 56a, 56b for the stripping operation. The first and second sets of blades 54a, 54b, 56a, 56b can contact the buffer layer 112 of the fiber optic cable 84 and push it into the elongate groove 168 during the stripping operation.

The centralizer 100 is configured to travel with the first and second sets of blades 54a, 54b, 56a, 56b during the stripping operation to allow self-centering by the first and second sets of blades 54a, 54b, 56a, 56b. In certain examples, the centralizer 100 has a thickness T_{c} of about 0.012 inches, although alternatives are possible. It will be appreciated that a width of the groove 168 and diameter of the circular closed end 170 of the centralizer 100 may vary with different types of cable.

The centralizer 100 provides for an alignment function for initial positioning of the fiber optic cable 84 before stripping. That is, as the first and second sets of blades 54a, 54b, 56a, 56b come together, the fiber optic cable ends up at the circular closed 170 of the groove 168 such that a precise positioning of the fiber optic cable can be achieved for the first and second sets of blades 54a, 54b, 56a, 56b to strip the fiber optic cable 84 without damage to the fiber. The first and second sets of blades 54a, 54b, 56a, 56b may be used with the centralizer 100 and first and second spacers 50, 52 to provide for accurate stripping of the fiber optic cable 84 without damaging the optical fiber within the coating layer 114 and the buffer layer 112.

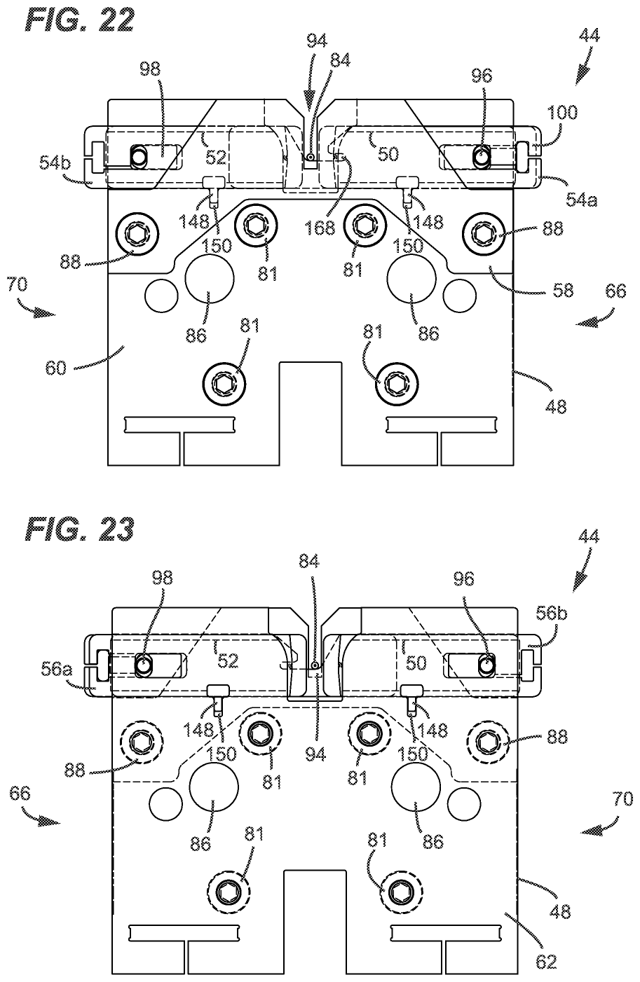

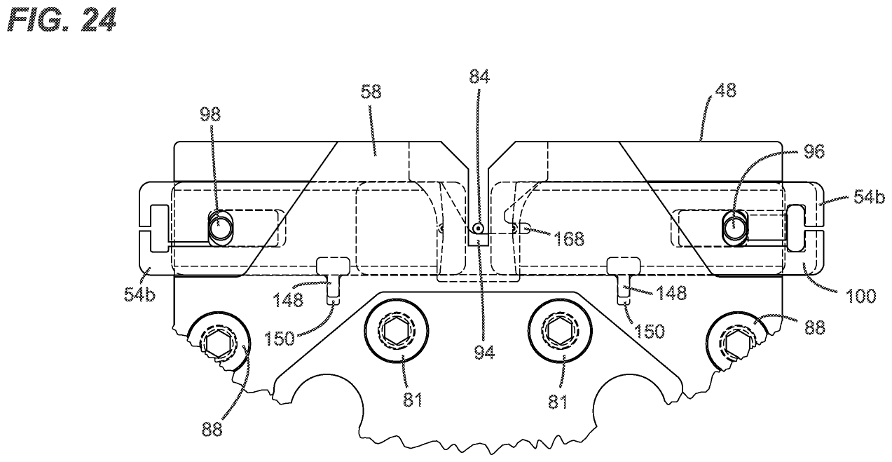

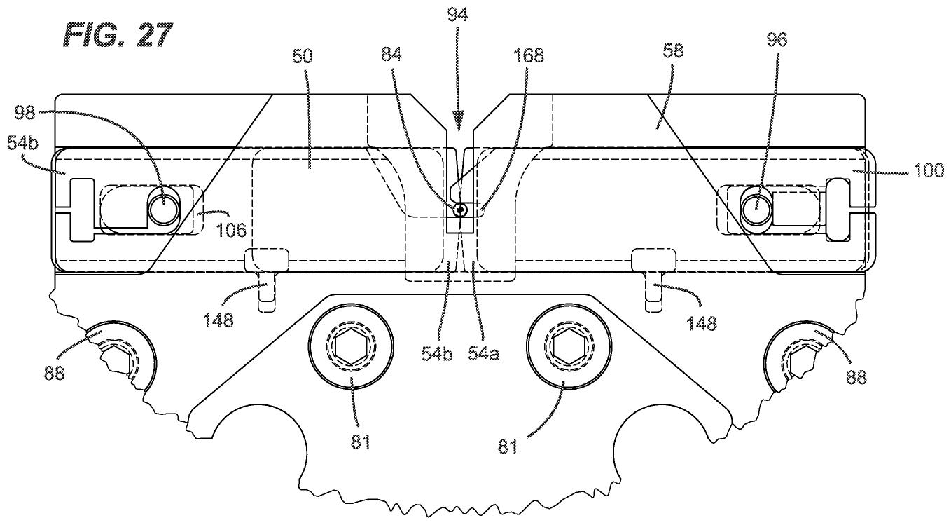

Turning to FIGS. 22-27, the double stripping fixture 44 is shown with the first and second sets of blades 54a, 54b, 56a, 56b, the first and second spacers 50, 52 and the centralizer 100 all arranged together in preparation of being mounted to the fiber optic cable processing apparatus 10 via pegs 96, 98. The pegs 96, 98 can move the first and second sets of blades 54a, 54b, 56a, 56b and the centralizer 100 laterally between an open and closed position during the stripping operation while the first and second spacers 50, 52 remain fixed. That is, the pegs 96, 98 control the motion of the first and second sets of blades 54a, 54b, 56a, 56b as they slide within the first and second grooves 76a, 76b, 80a, 80b defined by the first and second channels 64, 68, respectively.

FIGS. 22-24 show the first and second sets of blades 54a, 54b, 56a, 56b and the centralizer 100 in the open position prior to the stripping operation. The fiber optic cable 84 is also shown resting on the top edge 174 of the elongate groove 168 through the slot 94 defined by the cover plate 58.

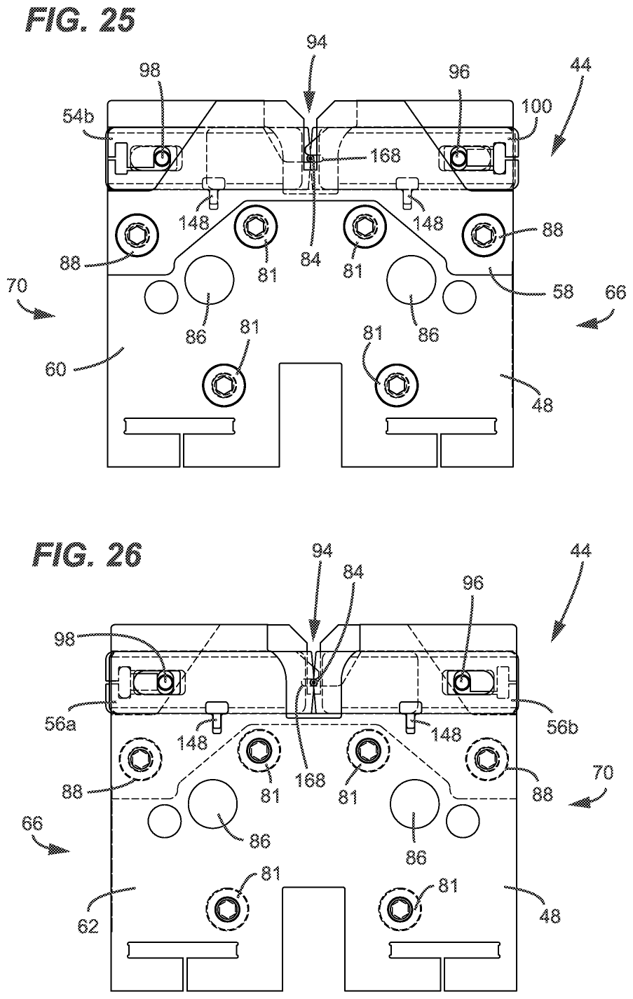

FIGS. 25-27 show the first and second sets of blades 54a, 54b, 56a, 56b and the centralizer 100 in the closed position for the stripping operation. As shown, the fiber optic cable 84 has moved past the tapering-out portion 172 into the elongate groove 168 such that the fiber optic cable 84 is horizontally aligned perfectly with the first and second sets of blades 54a, 54b, 56a, 56b. After the first and second sets of blades 54a, 54b, 56a, 56b cut into the fiber optic cable 84, the first and second sets of blades 54a, 54b, 56a, 56b are pulled back and the fiber optic cable 84 is allowed to retract. Because the first and second spacers 50, 52 are fixed or stationary, the first and second sets of blades 54a, 54b, 56a, 56b can retract past the first and second spacers 50, 52 to knock off any debris that may be stuck on the first and second sets of blades 54a, 54b, 56a, 56b. The stripped fiber is then ready for further processing, i.e. connectorization, splicing, etc.

Another aspect of the present disclosure relates to a method of removing a protective layer and a coating layer from a fiber optic cable. The method can include a step of providing a cable stripping tool. The cable stripping tool can include a clamp that is adapted to move axially to strip the protective and coating layers. The cable stripping tool can also include first and second sets of blades adapted to move radially inward and radially outward. The first set of blades can be spaced apart from the second set of blades by a spacer that can create a gap therebetween. The method can also include a step of moving the first and second sets of blades radially inward to engage the fiber optic cable. The method can also include a step of cutting the fiber optic cable to a first depth that extends through the protective layer of the fiber optic cable to expose the coating layer and simultaneously cutting the fiber optic cable to a second depth that extends through the protective layer and the coating layer of the fiber optic cable to expose a bare fiber. The method can further include a step of moving the clamp axially in a direction away from the first and second sets of blades to strip the protective layer and the coating layer from the fiber optic cable.

One application of the stripped fiber is for connectorization in a fiber optic connector that has a dual diameter ferrule. One portion of the ferrule adjacent the hub is sized for receipt of a 250 micron coated fiber, and a distal portion of the ferrule is sized for receipt of a 125 micron bare glass portion of the fiber. An example of a terminated fiber with a dual diameter ferrule is shown in U.S. Pat. No. 10,295,757, the disclosure of which is hereby incorporated in its entirety. As shown therein, the coated fiber portion extends past an end of the 900 micron buffer tube. It is preferred in one example that the coating length extends between about 1 millimeter to about 4 millimeters. In certain examples, the coating length is at least 1 millimeter to 3 millimeters long relative to the end of the 900 micron buffer tube. In another example, the coating length is at least 1.5 millimeters to 2.5 millimeters. In another example, the coated fiber portion may have a coating length that is about 2 millimeters long relative to the end of the 900 micron buffer tube.

With the above described tool, fixture and method, more consistent lengths of the coating are possible relative to an end of the 900 micron or other diameter buffer tube when a single cutting and stripping operation is performed with the dual cuts/blade sets including the spacer feature.

From the forgoing detailed description, it will be evident that modifications and variations can be made without departing from the spirit and scope of the disclosure.

What is claimed is:

1. A fiber optic cable processing apparatus for removing a buffer layer and a coating layer of a fiber optic cable, the fiber optic cable processing apparatus comprising:
a main body having a first end, a second end, a right side, and a left side, the main body including a control housing located at the first end of the main body that houses control electronics for operation of the apparatus, the main body also including an internal frame that supports actuation rods adapted to extend axially from the second end of the main body when stripping the fiber optic cable;
a clamping structure mounted at the first end of the main body onto the actuation rods, the clamping structure being adapted to clamp the fiber optic cable for stripping in a stripping process, wherein when the fiber optic cable processing apparatus is activated, the clamping structure is moved by the actuation rods in a direction extending away from the control housing for stripping the fiber optic cable;
mounting pegs extending from a front face of the main body; and
a double stripping fixture adapted to mount on the mounting pegs at the front face of the main body, the double stripping fixture including:
a guide plate including first and second sides, the guide plate defining a first channel at the first side, a second channel at the second side, and a cutout positioned between the first and second channels, the guide plate also defining apertures for receiving the actuation rods at the second end of the main body;
a spacer adapted to be inserted into the first and second channels of the guide plate, wherein the spacer includes a first major surface and an opposite second major surface;
a first set of blades adapted to be positioned within the first and second channels of the guide plate such that the first set of blades is positioned adjacent to the first major surface of the spacer, the first set of blades being mounted over the mounting pegs of the main housing, the mounting pegs being configured to move the first set of blades radially inwardly to cut the buffer layer such that the buffer layer is stripped away from the coating layer of the fiber optic cable such that the coating layer is exposed;
a second set of blades adapted to be positioned within the first and second channels of the guide plate such that the second set of blades is positioned adjacent to the second major surface of the spacer, wherein the spacer is configured to provide a gap between the first and second sets of blades positioned within the first and second channels of the guide plate, the second set of blades being mounted over the mounting pegs of the main housing, the mounting pegs being configured to move the second set of blades radially inwardly to cut the buffer layer and the coating layer such that the buffer layer and the coating layer are stripped away from the fiber optic cable to expose a bare optical fiber; and
a cover plate defining openings for receiving fasteners for mounting the cover plate to the guide plate.

2. The fiber optic cable processing apparatus of claim 1, wherein the spacer includes two pieces.

3. The fiber optic cable processing apparatus of claim 1, wherein the spacer is removable.

4. The fiber optic cable processing apparatus of claim 1, wherein edges of the first and second sets of blades define semi-circular notches.

5. The fiber optic cable processing apparatus of claim 4, wherein when the respective first and second sets of blades come together, a circular cutting hole is formed.

6. The fiber optic cable processing apparatus of claim 5, wherein the circular cutting hole defined by the first set of blades has a first total circle diameter and the circular cutting hole defined by the second set of blades has a second total circle diameter.

7. The fiber optic cable processing apparatus of claim 6, wherein the first total circle diameter is greater than the second total circle diameter.

8. The fiber optic cable processing apparatus of claim 1, wherein the first set of blades and the second set of blades simultaneously cut into the fiber optic cable during operation of the fiber optic cable processing apparatus.

9. The fiber optic cable processing apparatus of claim 1, further comprising a centralizer mounted adjacent to the first set of blades, wherein the centralizer is configured to position the fiber optic cable in a correct orientation both vertically and horizontally for stripping by the first and second sets of blades.

10. The fiber optic cable processing apparatus of claim 1, wherein the gap between the first and second sets of blades is about 2 millimeters.

11. The fiber optic cable processing apparatus of claim 1, wherein the gap between the first and second sets of blades is about 4 millimeters.

12. The fiber optic cable processing apparatus of claim 1, wherein the spacer is stationary relative to the first and second sets of blades during the stripping process.

13. A double stripping fixture for removing a buffer layer and a coating layer of a fiber optic cable, the double stripping fixture including:
a guide plate including first and second ends, the guide plate defining a first channel at the first end, a second channel at the second end, and a cutout positioned between the first and second channels;
a spacer adapted to be inserted into the first and second channels of the guide plate, wherein the spacer includes a first major surface and an opposite second major surface;
a first set of blades adapted to be positioned within the first and second channels of the guide plate such that the first set of blades is positioned adjacent to the first major surface of the spacer, the first set of blades being configured to strip the buffer layer away from the coating layer of the fiber optic cable such that the coating layer is exposed; and
a second set of blades adapted to be positioned within the first and second channels of the guide plate such that the second set of blades is positioned adjacent to the second major surface of the spacer, the second set of blades being configured to strip the buffer layer and the coating layer away from the fiber optic cable to expose a bare optical fiber;
wherein the spacer is configured to provide a gap between the first and second sets of blades positioned within the first and second channels of the guide plate, and wherein the first and second sets of blades cut the fiber optic cable simultaneously.

14. The double stripping fixture of claim 13, wherein the spacer is stationary relative to the first and second sets of blades during a stripping process.

15. The double stripping fixture of claim 13, wherein edges of the first and second sets of blades define semi-circular notches.

16. The double stripping fixture of claim 15, wherein when the respective first and second sets of blades come together, a circular cutting hole is formed.

17. The double stripping fixture of claim 16, wherein the circular cutting hole defined by the first set of blades has a first total circle diameter and the circular cutting hole defined by the second set of blades has a second total circle diameter.

18. The double stripping fixture of claim 17, wherein the first total circle diameter is greater than the second total circle diameter.

19. The double stripping fixture of claim 13, wherein the spacer includes two pieces.

20. The double stripping fixture of claim 13, wherein the spacer is a single piece.

21. The double stripping fixture of claim 13, wherein the spacer is removable.

22. The double stripping fixture of claim 13, further comprising a centralizer mounted adjacent to the first set of blades, wherein the centralizer is configured to position the fiber optic cable in a correct orientation both vertically and horizontally for stripping by the first and second sets of blades.

23. A double stripping fixture for removing a buffer layer and a coating layer from a fiber optic cable, the double stripping fixture including:
a guide plate defining a first channel and a second channel;
a cover plate configured to mount over the guide plate;
a spacer configured to be inserted into the first and second channels of the guide plate, wherein the spacer includes a first major surface and an opposite second major surface;
a first set of blades configured to be positioned within the first and second channels of the guide plate such that the first set of blades is positioned adjacent to the first major surface of the spacer, the first set of blades being configured to cut into the buffer layer to strip the buffer layer away from the coating layer of the fiber optic cable such that the coating layer is exposed; and
a second set of blades configured to be positioned within the first and second channels of the guide plate such that the second set of blades is positioned adjacent to the second major surface of the spacer, the second set of blades being configured to cut into the buffer layer and the coating layer to strip the buffer layer and the coating layer away from the fiber optic cable to expose a bare optical fiber;
wherein the spacer is configured to provide a gap between the first and second sets of blades positioned within the first and second channels of the guide plate, and wherein the first and second sets of blades cut the fiber optic cable simultaneously.

24. The double stripping fixture of claim 23, wherein the spacer includes two pieces.

25. The double stripping fixture of claim 23, wherein the spacer is a single piece.

26. The double stripping fixture of claim 23, wherein the spacer is removable.

27. The double stripping fixture of claim 23, wherein the spacer is stationary relative to the first and second sets of blades during a stripping process.

28. A method of removing a protective layer and a coating layer from a fiber optic cable, the method comprising:
providing a cable stripping tool, the cable stripping tool including a clamp that is adapted to move axially to strip the protective and coating layers, the cable stripping tool including first and second sets of blades adapted to move radially inward and radially outward, the first set of blades being spaced apart from the second set of blades by a spacer, the spacer creating a gap therebetween;
moving the first and second sets of blades radially inward to engage the fiber optic cable;
cutting the fiber optic cable to a first depth that extends through the protective layer of the fiber optic cable to expose the coating layer and simultaneously cutting the fiber optic cable to a second depth that extends through the protective layer and the coating layer of the fiber optic cable to expose a bare fiber; and
moving the clamp axially in a direction away from the first and second sets of blades to strip the protective layer and the coating layer from the fiber optic cable.

29. The method of claim 28, wherein the gap extends between about 1 millimeter to about 4 millimeters.
